(19) United States
(12) Patent Application Publication
(10) Pub. No.: US 2007/0164948 A1
(43) Pub. Date: Jul. 19, 2007

(54) Liquid crystal display

(76) Inventors: Jeong Il Kim, Incheon-Si (KR); Dong Gyu Kim, Yongin-Si (KR); Jong Woong Chang, Cheonan-Si (KR)

Correspondence Address: CANTOR COLBURN, LLP, 55 GRIFFIN ROAD SOUTH, BLOOMFIELD, CT, 06002, US

(21) Appl. No.: 11/509,902

(22) Filed: Aug. 25, 2006

(30) Foreign Application Priority Data
Jan. 13, 2006 (JP) 10-2006-0003995

(51) Int. Cl. G09G 3/36

(52) U.S. Cl. 345/87

(57) ABSTRACT

A liquid crystal display panel includes a plurality of gate lines, a gate driving unit mounted onto the liquid crystal display panel and connected to the plurality of gate lines and a plurality of lines applying an external signal to the gate driving unit. The plurality of lines are connected to different regions on the gate driving unit in accordance with a voltage level of the signal to be applied thereto.

This application claims priority to Korean Patent Application No. 10-2006-0003995 filed on Jan. 13, 2006 and all the benefits accruing therefrom under 35 U.S.C. §119, the contents of which are incorporated by reference in its entirety.

### BACKGROUND OF THE INVENTION

1. Field of the Invention

The present invention relates to a liquid crystal display, and more particularly, to a bonding configuration formed on a substrate and connected to a gate driving IC in a liquid crystal display with a chip on glass (COG) structure.

2. Description of the Related Art

A liquid crystal display (LCD) is a device that includes two opposite substrates formed with electrodes and a liquid crystal material inserted between the two opposite substrates. This LCD allows images to be displayed thereon by applying an electric field between the electrodes of the two opposite substrates and causing liquid crystal molecules to move in the liquid crystal material due to the applied electric field such that the light transmissivity of the liquid crystal material can be changed.

The liquid crystal display employs the optical anisotropy and polarizability of a liquid crystal. Since the liquid crystal is thin and long in view of its structure, the orientation of the liquid crystal molecules can be adjusted by applying the electric field to an array of the liquid crystal molecules with specific directivity and polarizability. Since the light can be transmitted or blocked in accordance with the orientation of the liquid crystal molecules due to the optical anisotropy of the liquid crystal if the orientation of the liquid crystal molecules is suitably adjusted, colors and images can be represented thereon. A TFT-LCD using a thin film transistor (TFT) as a switching element has been employed.

A plurality of thin film transistors are formed on a liquid crystal display panel and a plurality of gate lines and data lines are formed on the liquid crystal display panel. A plurality of pixel electrodes connected to the gate lines and the data lines through the thin film transistors are formed on the liquid crystal display panel. The thin film transistors control data signals transmitted through the data lines in accordance with gate signals transmitted through the gate lines and transmit the data signals to the pixel electrodes. The gate signals are supplied from a gate driving integrated circuit (IC) connected to the plurality of gate lines while the data signals are supplied from a data driving integrated circuit (IC) connected to the plurality of data lines.

The data driving IC is mounted onto a printed circuit board (PCB) and connected to the plurality of data lines through a flexible printed circuit board (FPCB). In the COG structure, the gate driving IC is bonded onto the liquid crystal display panel and connected to the plurality of gate lines.

The liquid crystal display panel is provided with a plurality of lines for providing external power to the gate driving IC and bonding pad portions connected to bumps of the gate driving IC are formed at the ends of the lines. Further, the bonding pad portions are formed only at one side of the gate driving IC and the corrosion of the bonding pad portions frequently occurs due to the large voltage difference in the electric power applied through the bonding pad portions. Therefore, there is a problem in that a poor operation of the liquid crystal display occurs.

### BRIEF SUMMARY OF THE INVENTION

An exemplary embodiment provides a liquid crystal display wherein corrosion of bonding pad portions can be reduced or effectively prevented by forming lines with a single metal film and separating the bonding pad portions connected to the lines with a large voltage difference from each other.

One exemplary embodiment provides a liquid crystal display including a liquid crystal display panel including a plurality of gate lines, a gate driving unit mounted onto the liquid crystal display panel and connected to the plurality of gate lines and a plurality of lines applying an external signal to the gate driving portion. The plurality of lines are connected to different regions on the gate driving unit in accordance with a voltage level of the signal to be applied thereto.

In another exemplary embodiment, the plurality of lines includes a plurality of power lines providing electric power and a plurality of signal lines applying a signal. Each of the plurality of lines includes a bonding pad. A first group of the power lines transmitting a first level of voltage is connected to a first region on the gate driving portion, and a second group of the power lines transmitting a second level of voltage is connected to a second region on the gate driving unit spaced apart from the first region. The first level of voltage may be a positive voltage and the second level of voltage may be a negative voltage.

In another exemplary embodiment, the first group of power lines includes a first power line transmitting a gate turn on voltage and a second power line transmitting a voltage driving the gate driving portion, and the second group of power lines includes a third power line supplying a ground voltage to the gate driving unit and a fourth power line transmitting a gate turn off voltage. The first and second regions may be formed on upper and lower sides of the gate driving unit, respectively. The first group of power lines may be connected to the first region across outer and inner regions of the gate driving portion. The bonding pads of the first group of power lines may be provided on the first region or a region adjacent to the first region and the bonding pads of the second group of power lines may also provided on the second region or a region adjacent to the second region.

In another exemplary embodiment, a dummy pad may be formed between the bonding pads.

In another exemplary embodiment, each of the power lines includes a connecting portion connected to the bonding pad and an extending portion extending from the connecting portion. A width of the extending portion may be in a range of about 1 to 10 times a length of a shorter side of the bonding pad.

In another exemplary embodiment, the signal lines are connected to any one of the first and second regions.

In another exemplary embodiment, the plurality of lines may be formed films including Al, Nd, Ag, Cr, Ti, Ta, Mo and a combination including at least one of the foregoing films.

Another exemplary embodiment provides a liquid crystal display including a liquid crystal display panel including a plurality of gate lines, a gate driving unit mounted onto the liquid crystal display panel and connected to the plurality of gate lines, and a plurality of lines applying an external signal to the gate driving portion. The plurality of lines are formed of a single metal film.

In an exemplary embodiment, the metal film may be one of Al, Nd, Ag, Cr, Ti, Ta, Mo and a combination including at least one of the foregoing films.

In another exemplary embodiment, the plurality of lines includes a plurality of power lines providing electric power and a plurality of signal lines applying a signal and are connected to the different regions on the gate driving unit in accordance with a voltage level of the signal transmitted therethrough. Some of the power lines transmitting a positive voltage are connected to one side of the gate driving unit and the other of the power lines transmitting a negative voltage are connected to the other side of the gate driving portion. The power lines transmitting the positive voltage may include a first power line transmitting a gate turn on voltage and a second power line transmitting a voltage driving the gate driving portion, and the power lines transmitting the negative voltage may include a third power line supplying a ground voltage to the gate driving unit and a fourth power line transmitting a gate turn off voltage. At this time, the power lines transmitting the positive voltage may be connected to the one side across outer and inner regions of the gate driving portion.

In another exemplary embodiment, the bonding pads of the first and second power lines electrically connected the gate driving unit are provided on the one side or a region adjacent to the one side, and the bonding pads of the third and fourth power lines electrically connected to gate driving unit is connected to the other side or a region adjacent to the other side. A dummy pad may be formed between the bonding pads. In another exemplary embodiment, each of the power lines includes a connecting portion connected to the bonding pad and an extending portion extending from the connecting portion, and a width of the extending portion is in a range of about 1 to 10 times a length of a shorter side of the bonding pad.

Another exemplary embodiment provides a thin film transistor substrate including a substrate including a plurality of gate lines and a mounting region on which a gate driving unit is mounted, the gate driving unit being connected to the plurality of gate lines, first and second pad portions formed on different sides of the mounting region, and first and second groups of lines formed of a single metal film and connected to the first and second pad portions in accordance with a voltage level of a signal transmitted therethrough.

In another exemplary embodiment, the metal film may be one of Al, Nd, Ag, Cr, Ti, Ta, Mo and a combination including at least one of the foregoing films.

In another exemplary embodiment, the first and second pad portions are provided on upper and lower sides of the mounting region, respectively. The first group of lines may be connected to the first pad portion across the outside and inside of the mounting region.

In another exemplary embodiment, one of the first and second groups of lines includes power lines transmitting a positive voltage, the other of the first and second groups of lines includes power lines transmitting a negative voltage, and at least one of the first and second groups of lines includes signal lines. The power lines transmitting the positive voltage may include a first power line transmitting a gate turn on voltage and a second power line transmitting a voltage driving the gate driving portion. The power lines transmitting the negative voltage may include a third power line supplying a ground voltage to the gate driving unit and a fourth power line transmitting a gate turn off voltage.

In another exemplary embodiment, the first and second pad portions includes bonding pads connected to the power lines and dummy pad formed between the bonding pads. Each of the power lines includes a connecting portion connected to the bonding pad and an extending portion extending from the connecting portion, and a width of the extending portion is in a range from about 1 to 10 times a length of a shorter side of the bonding pad.

In another exemplary embodiment, the first and second pad portions may further include bonding pads connected to the signal lines. A size of the bonding pad connected to the power line may be in a range of about 1 to 5 times a size of the bonding pad connected to the signal line.

Another exemplary embodiment provides a method of forming a liquid crystal display, the method including forming a liquid crystal display panel including a plurality of gate lines, disposing a gate driving unit on the liquid crystal display panel and connecting the gate driving unit to the plurality of gate lines, connecting a plurality of lines to different regions on the gate driving unit in accordance with a voltage level of an external signal to be applied thereto and applying the external signal from a plurality of lines to the gate driving unit.

### BRIEF DESCRIPTION OF THE DRAWINGS

The above and other objects, features and advantages of the present invention will become apparent from the following description of preferred embodiments given in conjunction with the accompanying drawings, in which:

FIG. 1 is a block diagram of an exemplary embodiment of a liquid crystal display according to the present invention;

FIG. 2 is an equivalent circuit diagram an exemplary embodiment of a pixel of a liquid crystal display according to the present invention;

FIG. 3 is a perspective view of an exemplary embodiment of a liquid crystal display according to the present invention;

FIG. 4 is a plan view illustrating an exemplary embodiment of a bonding region where a gate driving IC of a liquid crystal display according to the present invention is bonded;

FIGS. 5 and 6 are plan views illustrating exemplary embodiments of upper and lower bonding regions of a liquid crystal display according to the present invention, respectively;

FIG. 7 is a cross-sectional view of a bonding pad portion taken along line D-D of FIG. 6;

FIG. 8 is a plan view illustrating another exemplary embodiment of the lower bonding region of the liquid crystal display according to the present invention;

FIG. 9 is a cross-sectional view of the liquid crystal display taken along line D-D of FIG. 8;

FIG. 10 is a plan view illustrating another exemplary embodiment of the lower bonding region of the liquid crystal display according to the present invention; and

FIG. 11 is a cross-sectional view of the liquid crystal display taken along line E-E of FIG. 10.

### DETAILED DESCRIPTION OF THE INVENTION

Hereinafter, preferred embodiments of the present invention will be described in detail with reference to the accompanying drawings. However, the present invention is not limited to the embodiments described below but will be implemented in various different forms. The embodiments are provided only to complete the disclosure of the present invention and fully convey the scope of the present invention to those skilled in the art.

In the drawings, in order to clearly represent a variety of layers and regions, the thickness thereof have been exaggerated and like reference numerals designate like elements. Further, when a part of a layer, a film, a region, a plate, etc. is positioned on or above the other part, it means that the one part is positioned onto or just above the other part and a third part is interposed between the one part and the other part. Like numbers refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “below,” “lower”, “under,” “above”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “below” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

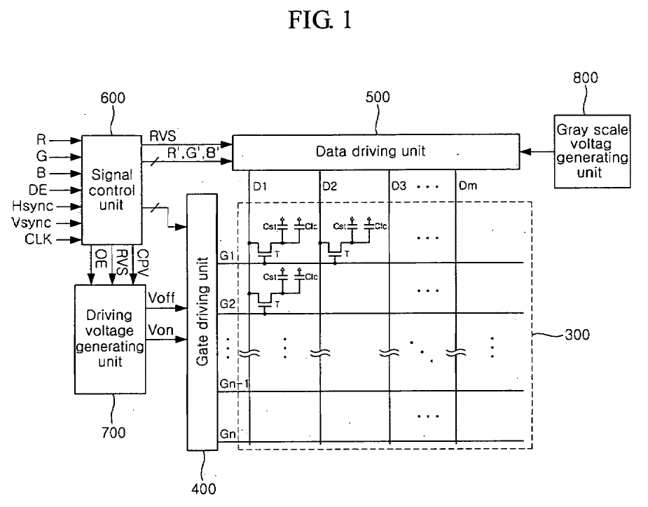

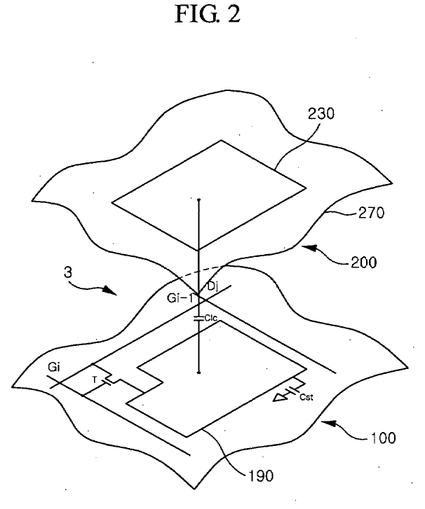

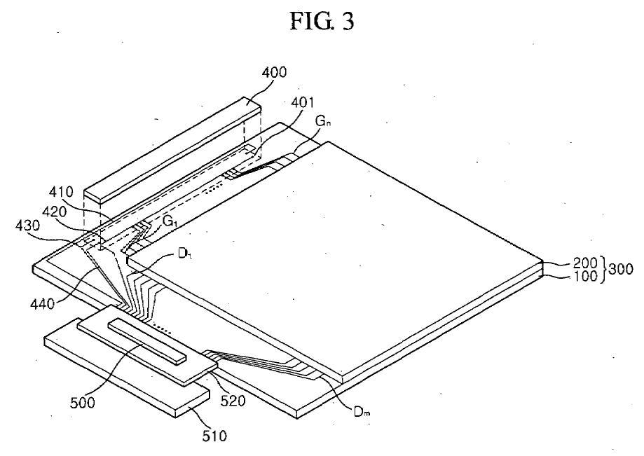

FIG. 1 is a block diagram of an exemplary embodiment of a liquid crystal display according to the present invention, FIG. 2 is an equivalent circuit diagram of an exemplary embodiment of a pixel of a liquid crystal display according to the present invention and FIG. 3 is a perspective view of an exemplary embodiment of a liquid crystal display according to the present invention.

Referring to FIGS. 1 to 3, a liquid crystal display includes a liquid crystal display panel 300 including thin film transistors, color filters and a liquid crystal layer to display desired images, a gate driving unit 400 and a data driving unit 500, each of which is connected to the liquid crystal display panel 300, a driving voltage generating unit 700 for supplying a driving voltage to the gate driving unit 400, a gray scale voltage generating unit 800 for supplying a gray scale voltage to the data driving unit 500 and a signal control unit 600 for controlling the above panel and units.

In one exemplary embodiment, the liquid crystal display panel 300 includes a plurality of display signal lines G1 to Gn and D1 to Dm and a plurality of pixels connected thereto. Each of the pixels includes a switching element T connected to each of the display signal lines G1 to Gn and D1 to Dm and a liquid crystal capacitor Clc and a storage capacitor Cst each of which is connected to the switching element T.

The display signal lines G1 to Gn and D1 to Dm includes a plurality of scanning signal lines or gate lines G1 to Gn extending substantially in a row direction and transmitting scanning signals or gate signals and a plurality of data signal lines or data lines D1 to Dm extending substantially in a column direction and transmitting image signals or data signals. The switching element T may be a three-terminal element including a control terminal connected to one of the gate lines G1 to Gn, an input terminal connected to one of the data lines D1 to Dm and an output terminal connected to a terminal of the liquid crystal capacitor Clc and the storage capacitor Cst.

Another terminal of the liquid crystal capacitor Clc is supplied a common voltage Vcom or a reference voltage. Another terminal of the storage capacitor Cst is supplied with a reference voltage.

FIG. 2 schematically shows a structure of a pixel region of the liquid crystal display panel 300 for displaying an image thereon. For illustrative purposes, only one pixel is shown in FIG. 2.

As shown in FIG. 2, the liquid crystal display panel 300 includes lower and upper substrates 100 and 200, respectively, facing each other and a liquid crystal layer 3 formed between the substrates. The lower substrate 100 may be considered a thin film transistor substrate including a thin film transistor and a pixel electrode 190. The upper substrate 200 may be considered a reference electrode substrate including a color filter 230 and a reference electrode 270. The lower substrate 100 is provided with gate lines Gi-l and Gi, the data line Dj, the switching element T and the storage capacitor Cst. The liquid crystal capacitor Clc is connected to and includes the pixel electrode 190 of the lower substrate 100 and the reference electrode 270 of the upper substrate 200 as two terminals. The liquid crystal layer 3 disposed between the two electrodes 190 and 270 functions as a dielectric.

The pixel electrode 190 is connected to the switching element T, while the reference electrode 270 is formed on an entire surface of the upper substrate 200 and connected to the common voltage Vcom. The orientation of the liquid crystal molecules is changed according to the electric field generated by the pixel electrode 190 and the reference electrode 270, such that the polarization of light passing through the liquid crystal layer 3 may also be changed.

In an alternative exemplary embodiment, the lower substrate 100 may be provided with an additional signal line (not shown), a portion of which may be overlapped with the pixel electrode 190 and to which the reference voltage is applied, to construct the storage capacitor Cst.

In the exemplary embodiment illustrated in FIG. 2, a MOS transistor is shown as an example of the switching element T and implemented by a thin film transistor employing an amorphous or polycrystalline silicon layer as a channel layer in an actual process.

In order to implement a color display, the liquid crystal display panel 300 may include the colored filter 230. The colored filter 230 may include colored filters such as a red, a green and/or a blue color filter 230, through which each pixel is able to represent colors at a region corresponding to the pixel electrode 190. As shown in FIG. 2, the color filter 230 may be formed on a region of the upper substrate 200 corresponding to the pixel electrode 190 in location, size and/or shape. In other exemplary embodiments, the color filter 230 may be formed above or below the pixel electrode 190 of the lower substrate 100.

In exemplary embodiments, a polarizer (not shown) for polarizing light may be attached to an outer surface of at least one of the upper and lower substrates 100 and 200 of the liquid crystal display panel 300.

Referring again to FIG. 1, the gray scale voltage generating unit 800 generates two sets of multiple gray scale voltages related to the light transmissivity of the pixel. In one exemplary embodiment, one set of voltages has a positive value relative to the common voltage while the other has a negative value relative to the common voltage. The gate driving unit 400 is connected to the gate lines G1 to Gn of the liquid crystal display panel 300 to apply the externally provided gate signals including a gate turn on voltage Von and a gate turn off voltage Voff from the outside to the gate lines G1 to Gn. The gate driving unit 400 may be implemented by a plurality of integrated circuits (ICs). The data driving unit 500 is connected to the data lines D1 to Dm of the liquid crystal display panel 300 to select the gray scale voltages from: the gray scale voltage generating unit 800 and to apply the selected gray scale voltages to the pixels as data signals. The data driving unit 500 may also be implemented by a plurality of integrated circuits (ICs). The signal control unit 600 generates control signals for controlling the operations of the gate driving unit 400 and the data driving unit 500 and sends relevant control signals to the gate driving unit 400 and the data driving unit 500, respectively.

Hereinafter, an exemplary embodiment of a physical structure of the liquid crystal display will be described with reference to FIG. 3.

As shown in FIG. 3, a printed circuit board 510 provided with circuit elements for operating the liquid crystal display is disposed at one side of the liquid crystal display panel 300. Circuit elements may include, but are not limited to, the signal control unit 600, the driving voltage generating unit 700, the gray scale voltage generating unit 800. In other words, the liquid crystal display panel 300 includes the lower and upper substrates 100 and 200, as described above, such that the size of the upper substrate 200 is relatively smaller than that of the lower substrate 100. A portion of one side of the lower substrate 100 is exposed to outside. FIG. 3 illustrates left and lower regions of the lower substrate 100 as being exposed and the printed circuit board 510 is disposed at one side of the exposed lower region.

The lower substrate 100 and the printed circuit board 510 are electrically and physically connected to each other through a flexible printed circuit board 520. The data driving unit 500, i.e. the data driving IC, may be bonded on the flexible printed circuit board 520. The data driving IC 500 is connected to the plurality of data lines D1 to Dm of the lower substrate 100 through the flexible printed circuit board 520. In an alternative exemplary embodiment the data driving IC 500 may be bonded on the lower substrate 100. In another exemplary embodiment, a plurality of the data driving ICs may be provided. In another exemplary embodiment, the flexible printed circuit board 520 may be provided with a plurality of data driving signal lines for connecting with the data driving unit 500 and a plurality of gate driving signal lines for controlling the gate driving unit 400.

A predetermined bonding region 401 is formed on the exposed left region of the lower substrate 100 and the gate driving unit 400, i.e. the gate driving IC is bonded to the bonding region 401. The bonding region 401 is illustrates as a substantially rectilinear (or rectangular) region, but may be any of a number of shapes as is suitable for the purpose described herein. The plurality of gate lines G1 to Gn of the lower substrate 100 are connected to the gate driving IC 400. The lower substrate 100 is provided with a plurality of lines 410, 420, 430 and 440 connecting the gate driving signal lines of the flexible printed circuit board 520 to the gate driving unit 400 in order to apply the gate driving signals to the gate driving IC 400 bonded to the lower substrate 100.

The lines 410, 420, 430 and 440 are divided, according to the levels of the applied voltages. In one exemplary embodiment, the lines 430 and 440 extend from the flexible printed circuit board 520 to one side of the gate driving unit 400 and are connected to the gate driving unit 400 The lines 410 and 420 extend from the flexible printed circuit board 520 to another side of the gate driving unit 400 which is across the one side or considered as the inside of the gate driving unit 400 and are connected to the gate driving unit 400.

The gate driving unit 400 may include any of a number of shapes as is suitable for the purposes described herein, including substantially in a form of a rectangle. As illustrated in FIG. 3, some portions of the lines 410, 420, 430 and 440 connected from the flexible printed circuit board 520 to the gate driving unit 400 extend in a direction toward the one side of the gate driving unit 400 while the other portions extend in a direction toward an other side of the gate driving unit 400, such as an opposing side. The lines 410 and 420 extend across the outside and/or inside of the gate driving unit 400, respectively. Contact pad portions may be formed at the ends of the lines and connected to connecting terminals of the gate driving unit 400.

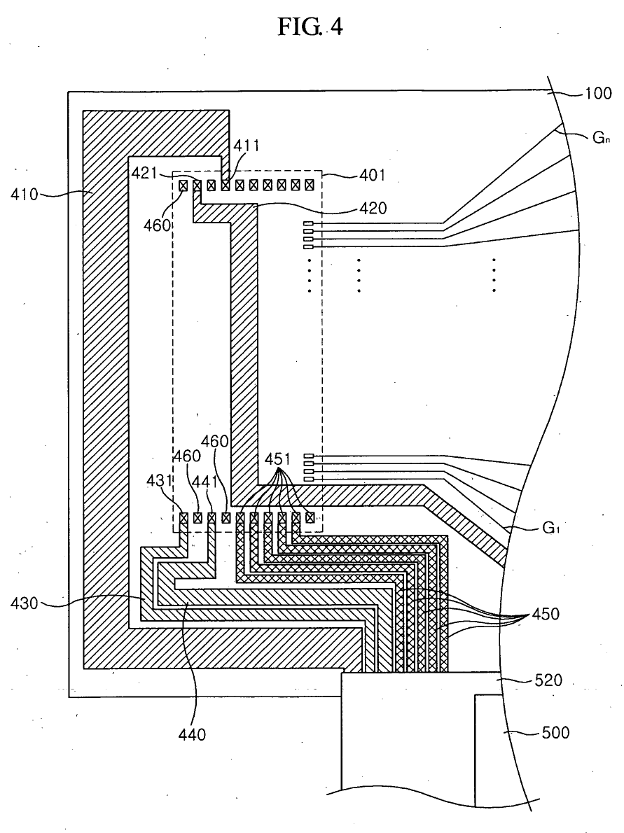

Hereinafter, an exemplary embodiment of a structure of the plurality of lines connected to the gate driving unit will be explained with reference to FIG. 4.

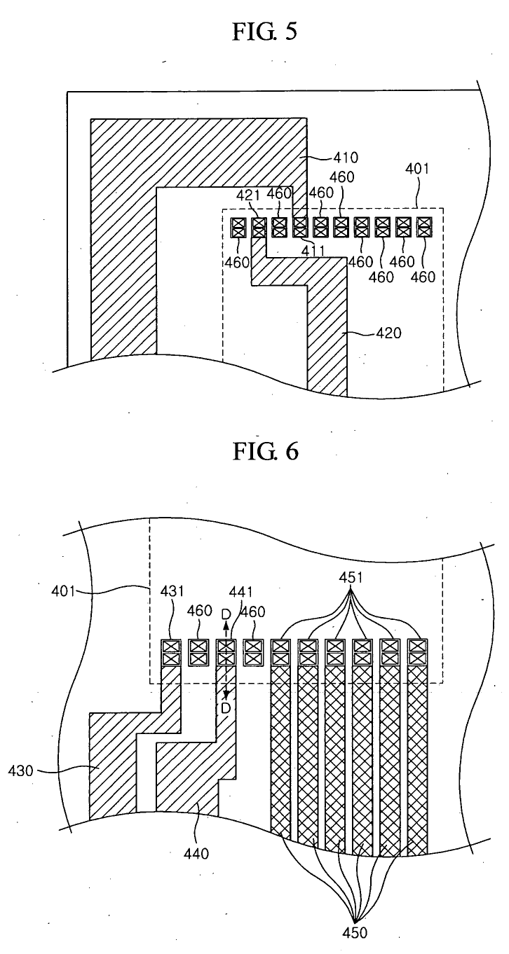

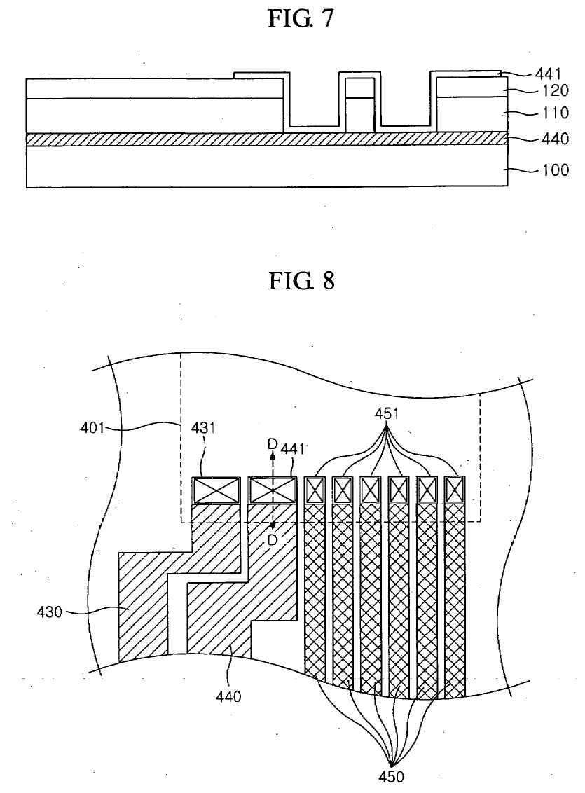

FIG. 4 is a plan view illustrating an exemplary embodiment of a bonding region (mounting region) to which a gate driving IC of the liquid crystal display according to the present invention is bonded. FIGS. 5 and 6 are plan views illustrating exemplary embodiments of upper and lower bonding regions of the liquid crystal display according to the present invention, respectively. FIG. 7 is a cross-sectional view of a bonding pad portion taken along line D-D of FIG. 6.

Referring to FIGS. 4 to 7, the lines 410, 420, 430, 440 and 450 include a plurality of power lines 410, 420, 430 and 440 for providing electric power and a logic signal line 450 for supplying a logic signal. The power lines 410, 420, 430 and 440 include the first power line 410 for supplying the gate turn on voltage, the second power line 420 for supplying a voltage for driving the gate driving unit 400, the third power line 430 for supplying a ground voltage to the gate driving unit 400 and the fourth power line for supplying the gate turn off voltage. One end of the lines 410, 420, 430, 440 and 450 is connected to the flexible printed circuit board 520 and the other ends thereof extend into the bonding region 401, to which the gate driving unit 400 will be bonded, such that the lines 410, 420, 430, 440 and 450 may be connected to a plurality of bonding pad portions 411, 421, 431, 441, 451 and 460 formed in the bonding region 401.

In exemplary embodiments, the lines 410, 420, 430, 440 and/or 450 may be formed of a single metal film. Advantageously, it may be possible to prevent the generation of voids which will cause the corrosion of the lines upon the formation of the contacts for forming the bonding pad portions.

An exemplary embodiment of a method of manufacturing the lines and the bonding pad portions connected to the lines will be briefly explained with reference to FIG. 7.

Any one of a number of types and/or material films may be formed on the lower substrate 100 and then patterned to form the power lines 410, 420, 430 and 440 and the signal line 450. The films may include, but are not limited to, Al, Nd, Ag, Cr, Ti, Ta and Mo. A plurality of gate electrodes (not shown) and the gate lines G1 to Gn may be simultaneously patterned on the inside of the lower substrate 100. In one preferred exemplary embodiment, the Cr film with a thickness of 500 to 5000 Å may be used to form the lines 410, 420, 430, 440 and 450.

Referring to FIG. 7, a gate insulating film 110 is formed on the lower substrate 100, an active layer (not shown) is formed on the gate electrode, and a source electrode (not shown) and a drain electrode (not shown) are formed such that the thin film transistor can be formed. The plurality of data lines D1 to Dm connected to the source electrodes are formed. A passivation film 120 is formed on the resultant structure and then patterned to form contact holes through which some portions of the lines 410, 420, 430, 440 and 450 may be exposed. Areas for connecting the lines to the bonding pad portions may be increased by forming first and second contact holes through which some portions of the lines are exposed. A transparent conductive film including, but not limited to, indium tin oxide (ITO) or indium zinc oxide (IZO) may be formed on the resultant structure and then patterned to form the pixel electrodes and the bonding pad portions 411, 421, 431, 441, 451 and 460.

In one exemplary embodiment, since each of the lines 410, 420, 430, 440 and 450 may be formed of a single Cr film, the interfacial resistance between the lines 410, 420, 430, 440 and 450 and the ITO film used as the bonding pad portions 411, 421, 431, 441, 451 and 460 may be lowered. In preferred exemplary embodiments, the thickness of the Cr film is increased to reduce the resistances of the lines 410, 420, 430, 440 and 450.

Resistances of the lines 410, 420, 430, 440 and 450 may be further reduced by increasing the widths of the power lines 410, 420, 430 and 440 for providing electric power. As illustrated in FIGS. 4 to 6, some of the lines 410, 420, 430, 440 and 450 have a relatively larger width compared to others of the lines 410, 420, 430, 440 and 450. A width may be considered in substantially left-to-right and/or top-to-bottom directions of the lines taken from a top view. Further, the bonding pad portions 411, 421, 431, 441, 451 and 460 may be simply brought contact with the gate driving unit 400 due to substantially similar or essentially identical sizes. In one exemplary embodiment, referring to FIGS. 5 and 6, a left-to-right width of the bonding pad portions 411, 421, 431, 441, 451 and 460 may range from about 0.1 μm to about 100 μm and the length (top-to-bottom distance) of the bonding pad portions may range from about 10 μm to about 900 μm.

The bonding pad portions 411, 421, 431, 441, 451 and 460 are disposed in the rectangular bonding region 401. Some of the bonding pad portions may be formed at an edge of one side of the bonding region adjacent to the flexible printed circuit board 520 and other of the bonding pad portions may be formed at another edge of the bonding region such as at an opposite side of the bonding region.

The lines 410, 420, 430, 440 and 450 may be divided according to the levels of the voltages applied to the lines. In one exemplary embodiment, some of the lines are connected to the lower bonding pad portions 431, 441 and 460 formed at the edge of one side of the bonding region 401 or the other of the lines may be connected to the upper bonding pad portions 411, 421 and 460 formed at the edge of the other (opposite) side of the bonding region 401.

As shown in FIG. 4, the first and second power lines 410 and 420 at a first voltage level extend across an outside and an inside of the bonding region 401 to connect to the first and second bonding pad portions 411 and 421 formed at the other side of the bonding region 401. The third and fourth power lines 430 and 440 at a second voltage level are connected to the third and fourth bonding pad portions 431 and 441 formed at the one side of the bonding region 401 adjacent to the flexible printed circuit board 520.

In exemplary embodiments, the first voltage level may be a positive voltage and the second voltage level may be a negative voltage. In one exemplary embodiment, the positive voltage is a voltage of 1 V or more and the negative voltage is a voltage of 0 V or lower. Since the potential difference between adjacent lines can be reduced by allowing the bonding pad portions, which are formed by partially exposing the first and second power lines 410 and 420 for applying the positive voltages, to be spaced apart from the bonding pad portions, which are formed by partially exposing the third and fourth power lines 430 and 440 for applying the negative voltages, the electron transfer between two metals with larger potential difference and the crosstalk can be avoided. Advantageously, the corrosion of the lines in the bonding pad portions may also be reduced or effectively prevented.

The first power line 410 is connected to the flexible printed circuit board 520 and extends across the other side, i.e. the left side of the bonding region 401 to connect to the first bonding pad portion 411 formed at the other side of the bonding region 401. The first power line 410 may be considered as including a first connecting portion connected to the flexible printed circuit board 520, a second connecting portion connected to the first boding pad portion 411 and an extending portion extending between the first and second connecting portions. In a preferred exemplary embodiment, the first and second connecting portions have substantially the same widths as that of the first bonding pad portion 411 and the extending portion have a width greater than that of the first bonding pad portion 411. In another preferred exemplary embodiment, when the length of the shorter side of the first bonding pad portion 411 is set to 1, the widths of the first and second connecting portions may be set in a range of about 1 to 2 and the width of the extending portion may be set in a range of about 1 to 10. Even though the first power line 410 is formed of a single metal film, the resistance of the line can be reduced. In one exemplary embodiment, the first power line 410 may transmit the gate turn on voltage of 10 to 40 V.

The second power line 420 is connected to the flexible printed circuit board 520 and extends across the inside of the bonding region 401 to connect to the second bonding pad portion 421 formed at the other side of the bonding region 401. The second power line 420 may be considered as including a first connecting portion connected to the flexible printed circuit board 520, a second connecting portion connected to the second bonding pad portion 421 and an extending portion extending between the first and second connecting portions. In a preferred exemplary embodiment, when the length of the shorter side of the second bonding pad portion 421 is set to 1, the widths of the first and second connecting portions may be set in a range of about 1 to 2 and the width of the extending portion may be set in a range of about 1 to 10. In one exemplary embodiment, the second power line 420 may transmit the driving voltage of 3 to 10 V for driving the gate driving unit 400.

The third power line 430 is connected to the flexible printed circuit board 520 and also to the third bonding pad portion 431 formed at the one side of the bonding region 401 adjacent to the flexible printed circuit board 520. The third power line 430 may be considered as including a first connecting portion connected to the flexible printed circuit board 520, a second connecting portion connected to the third bonding pad portion 431 and an extending portion extending between the first and second connecting portions. In a preferred exemplary embodiment, when the length of the shorter side of the third bonding pad portion 431 is set to 1, the widths of the first and second connecting portions may be set in a range of about 1 to 2 and the width of the extending portion may be set in a range of about 1 to 10. In one exemplary embodiment, the third power line 430 may transmit the ground voltage of 0 V to the gate driving unit 400.

The fourth power line 440 is connected to the flexible printed circuit board 520 and also to the fourth bonding pad portion 441 formed at the one side of the bonding region 401. The fourth power line 440 may be considered as including a first connecting portion connected to the flexible printed circuit board 520, a second connecting portion connected to the fourth bonding pad portion 441 and an extending portion extending between the first and second connecting portions. In a preferred exemplary embodiment, when the length of the shorter side of the fourth bonding pad portion 441 is set to 1, the widths of the first and second connecting portions may be set in a range of about 1 to 2 and the width of the extending portion may be set in a range from about 1 to 10. In one exemplary embodiment, the fourth power line 440 transmits the gate turn off voltage of −30 to −10 V.

The plurality of signal lines 450 shown in FIG. 4 are formed at one side of the flexible printed circuit board 520 and the bonding region 401 and connected to a plurality of the fifth bonding pad portions 451. Alternative exemplary embodiments include configurations where the signal lines 450 may also be formed at all the other sides including one side and the other side of the bonding region 401.

The first to fourth power lines 410, 420, 430 and 440 and the signal lines 450 may be bent in multiple locations, such as starting from the flexible printed circuit board 520 and at connections to the first to fifth bonding pad portions 411, 421, 431, 441 and 451. The third and fourth power lines 430 and 440 and the signal lines 450 are disposed between the first and second lines 410 and 420. The right edge of the bonding region 401, i.e. a bonding region adjacent to the upper substrate 200, is provided with a plurality of gate pad portions connected to the gate lines G1 to Gn.

As shown in the exemplary embodiments in FIGS. 5 and 6, the voltage difference between the bonding pad portions 411, 421, 431, 441 and 451 may also be reduced by forming the dummy pad portions 460 between the first to fifth bonding pad portions 411, 421, 431, 441 and 451. As shown in FIG. 5, the dummy pad portions 460 can be formed between the first and second bonding pad portions 411 and 421. As shown in FIG. 6, the dummy pad portions 460 can be formed between the third and fourth bonding pad portions 431 and 441 and the dummy pad portions 460 can also be formed between the fourth and fifth bonding pad portions 441 and 451.

In exemplary embodiments, one dummy pad portion 460 may be disposed between the bonding pad portions 411, 421, 431, 441 and/or 451, but the present invention is not limited thereto. In alternative exemplary embodiments, a plurality of dummy pad portions 460 may be formed between the respective bonding pad portions. In other alternative exemplary embodiments, the dummy pad portions 460 may be used in a state where they have been connected to the adjacent bonding pad portions.

In the illustrated exemplary embodiments, the plurality of bonding pad portions are formed within the bonding region, to which the gate driving unit is connected, to be connected to bumps of the gate driving unit. However, the present invention is not limited thereto, and the first to fourth bonding pad portions connected to the power lines may be disposed outside of the bonding region and then connected to the gate driving unit through wires.

Additionally, the bonding pad portions connected to the power lines are formed at one side and the other side of the bonding region (the upper and lower sides as viewed from the figure). In preferred illustrated exemplary embodiments, a plurality of power input terminals of the gate driving portion, i.e. the bumps, are formed at one side and the other side on a bottom surface of the gate driving unit such that the bumps correspond to the bonding pad portions.

Further, the power lines and bonding pad portions of the present invention is not limited thereto, but may be modified in various ways. Another exemplary embodiment is described below wherein the gate driving unit of the liquid crystal display is connected to one side, i.e. a lower side, of the bonding region will be explained. In this exemplary. embodiment, the descriptions same as those in the previous embodiment will be omitted herein.

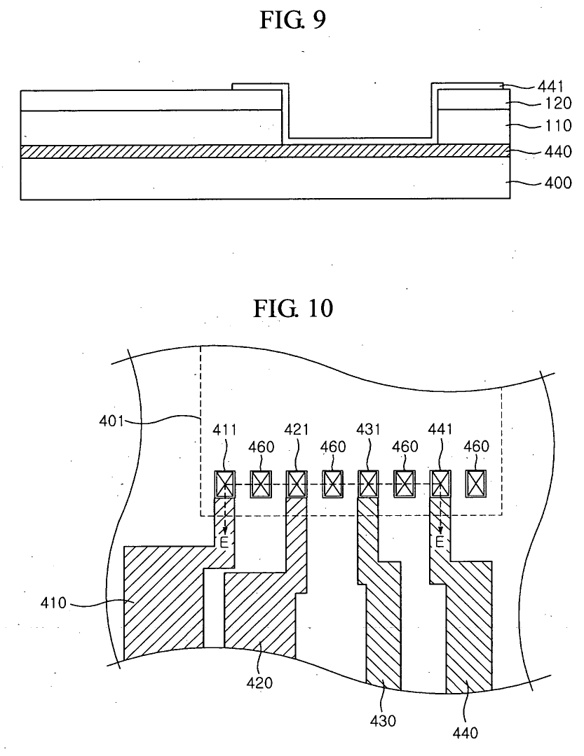

FIG. 8 is a plan view illustrating another exemplary embodiment of the lower bonding region of the liquid crystal display according to the present invention and FIG. 9 is a cross-sectional view of the liquid crystal display taken along line D-D of FIG. 8.

Referring to FIGS. 8 and 9, the third and fourth bonding pad portions 431 and 441 are formed larger than the fifth bonding pad portion 451. The first and second bonding pad portions 411 and 421 may also be formed larger than the fifth bonding pad portion 451. In other words, the bonding pad portions 411, 421, 431 and 441 connected to the power lines 410, 420, 430 and 440 are formed larger than the bonding pad portion 451 connected to the signal line 450. In one exemplary embodiment, the third and fourth bonding pad portions 431 and 441 are formed 1 to 5 times larger than the fifth bonding pad portion 451. Of course, the present invention is not limited thereto, and the first to fourth bonding pad portions 411, 421, 431 and 441 may be formed in such a manner that the left-to-right width of the first and fourth bonding pad portions are equal to the widths of the first to fourth power lines 410, 420, 430 and 440. In one exemplary embodiment, the power lines can be connected to the bonding pad portions in a state where the power lines are not bent.

As shown in FIG. 9, since the power lines are formed of a single metal film, the width of the metal film can be increased. Therefore, the internal resistances of the lines can be reduced. Since the size of the bonding pad portions may then be, the connection area between the bonding pad portions and the power lines can be increased. Advantageously, the contact resistance between the bonding pad portions and the power lines can also be reduced.

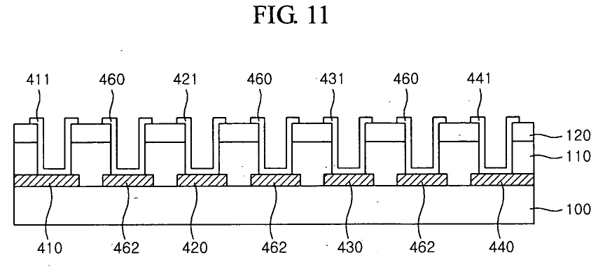

FIG. 10 is a plan view illustrating another exemplary embodiment of the lower bonding region of the liquid crystal display according to the present invention and FIG. 11 is a cross-sectional view of the liquid crystal display taken along line E-E of FIG. 10.

In FIGS. 10 and 11, the first to fourth bonding pad portions 411, 421, 431 and 441 connected to the first to fourth power lines 410, 420, 430 and 440 are formed at one side of the bonding region. A dummy pad portion 460 is formed between the first to fourth bonding pad portions 411, 421, 431 and 441, respectively, such that the dummy pad portions 460 alternate with the first to fourth bonding pad portions 411, 421, 431 and 441.

In exemplary embodiments, the bonding pad portions 411, 421, 431 and 441 are formed at the one side of the bonding region 401 adjacent to the flexible printed circuit board 520. The extension lengths of the first to fourth power lines 410, 420, 430 and 440 may be reduced. In one exemplary embodiment, the fifth bonding pad portions 451 for use in the plurality of signal lines 450 be formed at another side of the bonding region 401. In another exemplary embodiment, the fifth bonding pad portions 451 for use in the signal lines 450 may be formed at a side corresponding to the region where the bonding pad portions for the gate connection are formed.

Since the dummy pad portions 460 are formed between the first to fourth bonding pad portions 411, 421, 431 and 441, respectively, the electrical interference due to the voltage difference between the power lines exposed through the bonding pad portions can be reduced.

Another exemplary embodiment of a method of manufacturing the liquid crystal display panel having the dummy pad portions 460 will be explained with reference to FIG. 11. A single metal film is formed on the lower substrate 100 and then patterned to form the plurality of power lines 410, 420, 430 and 440, the signal lines 450, the gate lines G1 to Gn, the gate electrodes and dummy line patterns 462. The dummy line patterns 462 are formed between the power lines 410, 420, 430 and 440, respectively.

The gate insulating film 110, the active layer, the ohmic contact layer and the conductive film are formed on the resultant structure and then patterned to form the source and drain electrodes on the gate electrode and the data lines D1 to Dm connected to the source electrode. The passivation film 120 is formed on the resultant structure and then patterned to form the contact holes through which some portions of the power lines 410, 420, 430 and 440, the signal lines 450 and the dummy line patterns 462 are exposed, and a contact hole through a portion of the drain electrode is exposed.

A film, such as an ITO film, is applied onto the resultant structure and then patterned to form the pixel electrode connected to the drain electrode through the contact hole and to form the bonding pad portions 411, 421, 431, 441 and 451 and the dummy pad portions 460 that are connected to the power lines 410, 420, 430 and 440, the signal lines 450 and the dummy line patterns 462, respectively.

As the dummy pad portions 460 are formed between the first to fourth bonding pad portions 411, 421, 431 and 441, respectively, a space corresponding to an area of the dummy pad portions is provided at the outside edge of the bonding region 401 between the first to fourth bonding pad portions 411, 421, 431 and 441. In this space, the first to fourth power lines 410, 420, 430 and 440 can be more widely patterned. As shown in FIG. 10, since the first and second power lines 410 and 420 can be bent in a direction opposite to the third and fourth power lines 430 and 440, the widths of the first to fourth power lines 410, 420, 430 and 440 can be sufficiently increased. Advantageously, the internal resistances of the lines made of the single metal film can also be reduced.

In exemplary embodiments, since the plurality of lines are formed of a single metal film, the corrosion of the lines in the bonding pad region where the lines are exposed can be prevented. Advantageously, the signal distortion and the breakage or disconnection of lines may be reduced or effectively prevented.

In another exemplary embodiment, since regions where the bonding pad portions connected to the gate driving unit are formed are changed in accordance with the voltage levels of the lines for supplying external power to the gate driving portion, the corrosion of the bonding pad portions may be reduced or effectively prevented.

In another exemplary embodiment, the resistance of the lines may also be reduced by increasing the sectional areas of the lines.

In another exemplary embodiment, since the dummy pads are formed between the bonding pads, respectively, the electric interference between the exposed lines and the corrosion of the lines due to the electric interference may be reduced or effectively prevented.

Although the present invention has been described with reference to the preferred embodiments illustrated in connection with the accompanying drawings, the present invention is not limited thereto but is defined by the appended claims. Therefore, it will be readily understood by those skilled in the art that various modifications and changes can be made thereto without departing from the spirit and scope of the present invention defined by the appended claims.

What is claimed is:

1. A liquid crystal display, comprising:
a liquid crystal display panel comprising a plurality of gate lines;
a gate driving unit disposed on the liquid crystal display panel and connected to the plurality of gate lines; and
a plurality of lines applying an external signal to the gate driving unit,
wherein the plurality of lines are connected to different regions on the gate driving unit in accordance with a voltage level of the signal to be applied thereto.

2. The liquid crystal display as claimed in claim 1, wherein the plurality of lines comprises a plurality of power lines providing electric power and a plurality of signal lines applying a signal, each of the plurality of lines comprising a bonding pad.

3. The liquid crystal display as claimed in claim 2, wherein a first group of the power lines transmitting a first level of voltage are connected to a first region on the gate driving unit and a second group of the power lines transmitting a second level of voltage are connected to a second region on the gate driving unit spaced apart from the first region.

4. The liquid crystal display as claimed in claim 3, wherein the first level of voltage is a positive voltage and the second level of voltage is a negative voltage.

5. The liquid crystal display as claimed in claim 3, wherein the first group of power lines comprises a first power line transmitting a gate turn on voltage and a second power line transmitting a voltage driving the gate driving unit and the second group of power lines comprises a third power line supplying a ground voltage to the gate driving unit and a fourth power line transmitting a gate turn off voltage.

6. The liquid crystal display as claimed in claim 3, wherein the first and second regions are formed on upper and lower sides of the gate driving unit, respectively.

7. The liquid crystal display as claimed in claim 6, wherein the first group of power lines is connected to the first region across outer and/or inner regions of the gate driving unit.

8. The liquid crystal display as claimed in claim 3, wherein the bonding pads of the first group of power lines are provided on the first region or a region adjacent to the first region and the bonding pads of the second group of power lines are provided on the second region or a region adjacent to the second region.

9. The liquid crystal display as claimed in claim 2, wherein a dummy pad can be formed between bonding pads.

10. The liquid crystal display as claimed in claim 2, wherein each of the power lines comprises a connecting portion connected to the bonding pad and an extending portion extending from the connecting portion; and
wherein a width of the extending portion is in a range of 1 to 10 times a length of a shorter side of the bonding pad.

11. The liquid crystal display as claimed in claim 2, wherein the signal lines are connected to any one of the first and second regions.

12. The liquid crystal display as claimed in claim 1, wherein the plurality of lines are formed of films comprising one of Al, Nd, Ag, Cr, Ti, Ta, Mo and a combination including at least one of the foregoing.

13. A liquid crystal display, comprising:
a liquid crystal display panel comprising a plurality of gate lines;
a gate driving unit mounted onto the liquid crystal display panel and connected to the plurality of gate lines; and
a plurality of lines applying an external signal to the gate driving unit,
wherein the plurality of lines are formed of a single metal film.

14. The liquid crystal display as claimed in claim 13, wherein the metal film is one of Al, Nd, Ag, Cr, Ti, Ta, Mo and a combination including at least one of the foregoing films.

15. The liquid crystal display as claimed in claim 13, wherein the plurality of lines comprises a plurality of power lines providing electric power and a plurality of signal lines applying a signal, wherein the plurality of power lines are connected to different regions on the gate driving unit in accordance with a voltage level of the signal transmitted therethrough.

16. The liquid crystal display as claimed in claim 15, wherein some of the power lines transmit a positive voltage and are connected to one side of the gate driving unit and other of the power lines transmit a negative voltage and are connected to the other side of the gate driving unit.

17. The liquid crystal display as claimed in claim 16, wherein the power lines transmitting the positive voltage comprise a first power line transmitting a gate turn on voltage and a second power line transmitting a voltage driving the gate driving unit and the power lines transmitting the negative voltage comprise a third power line supplying a ground voltage to the gate driving unit and a fourth power line transmitting a gate turn off voltage.

18. The liquid crystal display as claimed in claim 16, wherein the power lines transmitting the positive voltage are connected to the one side across outer and/or inner regions of the gate driving unit.

19. The liquid crystal display as claimed in claim 15, wherein the bonding pads of the first and second power lines electrically connected the gate driving unit are provided on the one side or a region adjacent to the one side and the bonding pads of the third and fourth power lines electrically connected to gate driving unit are connected to the other side or a region adjacent to the other side.

20. The liquid crystal display as claimed in claim 19, wherein a dummy pad is formed between bonding pads.

21. The liquid crystal display as claimed in claim 19, wherein each of the power lines comprises a connecting portion connected to the bonding pad and an extending portion extending from the connecting portion and a width of the extending portion is in a range of about 1 to 10 times a length of a shorter side of the bonding pads.

22. A thin film transistor substrate, comprising:
a substrate comprising a plurality of gate lines and a mounting region on which a gate driving unit is mounted, the gate driving unit being connected to the plurality of gate lines;
first and second pad portions formed on different sides of the mounting region; and
first and second groups of lines formed of a single metal film and respectively connected to the first and second pad portions in accordance with a voltage level of a signal transmitted therethrough.

23. The thin film transistor substrate as claimed in claim 22, wherein the metal film is one of Al, Nd, Ag, Cr, Ti, Ta, Mo and a combination including at least one of the foregoing films.

24. The thin film transistor substrate as claimed in claim 22, wherein the first and second pad portions are provided on upper and lower sides of the mounting region, respectively.

25. The thin film transistor substrate as claimed in claim 24, wherein the first group of lines is connected to the first pad portion across the outside and/or inside of the mounting region.

26. The thin film transistor substrate as claimed in claim 22, wherein one of the first and second groups of lines comprises power lines and transmits a positive voltage, the other of the first and second groups of lines comprises power lines and transmits a negative voltage and at least one of the first and second groups of lines comprises signal lines.

27. The thin film transistor substrate as claimed in claim 26, wherein the power lines transmitting the positive voltage comprise a first power line transmitting a gate turn on voltage and a second power line transmitting a voltage driving the gate driving unit and the power lines transmitting the negative voltage comprise a third power line supplying a ground voltage to the gate driving unit and a fourth power line transmitting a gate turn off voltage.

28. The thin film transistor substrate as claimed in claim 26, wherein the first and second pad portions comprise bonding pads connected to the power lines and dummy pads formed between the bonding pads.

29. The thin film transistor substrate as claimed in claim 28, wherein each of the power lines comprises a connecting portion connected to the bonding pad and an extending portion extending from the connecting portion, and a width of the extending portion is in a range of about 1 to 10 times a length of a shorter side of the bonding pad.

30. The thin film transistor substrate as claimed in claim 26, wherein the first and second pad portions further comprises bonding pads connected to the signal lines, and a size of the bonding pad connected to the power lines is in a range of about 1 to 5 times a size of the bonding pad connected to the signal line.

31. A method of forming a liquid crystal display, the method comprising:
forming a liquid crystal display panel comprising a plurality of gate lines;
disposing a gate driving unit on the liquid crystal display panel and connecting the gate driving unit to the plurality of gate lines;
connecting a plurality of lines to different regions on the gate driving unit in accordance with a voltage level of an external signal to be applied thereto.
